(19) United States
(12) Patent Application Publication
(10) Pub. No.: US 2024/0230010 A9
(43) Pub. Date: Jul. 11, 2024

(54) DEVICE AND METHOD FOR ELIMINATION OF A LEAK IDENTIFIED IN AN EXPANSION JOINT OF A GAS PIPE IN OPERATION

(71) Applicant: PETRÓLEO BRASILEIRO S.A. - PETROBRAS, Rio de Janeiro (BR)

(72) Inventors: Elbert Fernando Martins Coelho, Betim (BR); Wagner Henrique Saldanha, Betim (BR)

(73) Assignee: PETRÓLEO BRASILEIRO S.A. - PETROBRAS, Rio de Janeiro (BR)

(21) Appl. No.: 18/490,835

(22) Filed: Oct. 20, 2023

(30) Foreign Application Priority Data
Oct. 21, 2022 (BR) BR1020220214573

(51) Int. Cl. F16L 55/17

(52) U.S. Cl. CPC F16L 55/17

(57) ABSTRACT

The present invention relates to devices and methods for containing gas leaks in pipelines. In particular, the present invention describes a device for eliminating gas leaks by sealing a gas leak in an expansion joint arranged between two pipes misaligned with each other, the device comprising a metallic structure comprising a sealing blanket, in which the metallic structure and blanket fully enclose the expansion joint using cables. In addition, the present invention describes a gas leak elimination device for sealing a gas leak in an expansion joint arranged between two aligned pipes, the device comprising a sealing blanket, steel cables, straps and fastening elements to fully enclose the expansion joint.

### CROSS-REFERENCE TO RELATED APPLICATION

This application claims under 35 U.S.C. § 119(a) priority to and the benefit of Brazilian Patent Application No. 10 2022 021457 3, filed Oct. 21, 2022, which is incorporated by reference herein in its entirety.

### FIELD OF THE INVENTION

The present invention relates to the technical field of pipelines transporting gas at high temperature and, more particularly, to devices and methods for containing gas leaks in pipelines.

### BACKGROUND OF THE INVENTION

Nowadays, expansion joints are used on a large scale in the most diverse sectors, such as in the steel, metallurgical, chemical and petrochemical industries, for example, being fundamental elements for absorbing vibrations, thermal expansion and misalignment in pipelines.

Furthermore, expansion joints are practical, efficient items and often tailored to the needs of each application. As an example, depending on the characteristics of the piping, the joints can have various shapes and sizes, such as round, square, rectangular, articulated and tubular models, which can be manufactured in metal, rubber, among other materials.

In particular, expansion joints are used in pipes that transport gases at high temperatures, such as, for example, CO₂ at approximately 465° C. in a gas transport pipeline for a boiler, and, in these cases in particular, tears and holes in the fabric of the joints can be cited as the most common types of failures.

Gas leakage through these failures causes loss of production efficiency, which is undesirable, as well as high noise and environmental contamination in the unit itself and in neighboring units, in addition to posing a risk to people in nearby areas.

However, maintenance with the unit in operation becomes virtually unfeasible due to the risks of the activity, even if equipment such as fans are used to displace the heat.

In addition to this difficulty, it should be noted that stopping fluid flow for maintenance operations is undesirable, if not impractical, due to loss of production.

Currently, some solutions are proposed for the types of problems mentioned above, such as, for example, replacing an old, damaged joint bellows with a new one, maintaining the mechanical and thermal properties of the equipment. However, these types of change are related to the project and can only be carried out when the equipment involved stops, due to safety conditions (high temperature, product), which leads to reduced reliability, financial loss and product shortages, for example.

Among other solutions commonly used, the riveted repair located in the region of the defective bellows and the flexible expansion joint “cap” stand out. However, these types of repairs must also be carried out with the equipment stopped, due to long-term exposure to high temperatures of the person carrying out the repair, in addition to implying rigorous analysis of the flexibility of the components for situations where the “cap” is applied which fixes the tear.

In view of the difficulties addressed, it was necessary to develop a solution that does not compromise the operation of the unit in service, being a safe solution, and that makes it possible to eliminate gas leaks in the expansion joint with the piping in operation, without loss of production, and that meets alignment and/or misalignment piping conditions.

### SUMMARY OF THE INVENTION

Misaligned Situation:

The present invention relates to a device for eliminating gas leaks by sealing a gas leak in an expansion joint arranged between two pipes misaligned with each other, the device comprising a metallic structure comprising a sealing blanket, in which the metallic structure and blanket fully surround the expansion joint using cables.

In a preferred embodiment, the metallic structure comprises a plurality of limiters, preferably arranged at an acute angle (e.g., about 22.5°) with respect to each other, comprising three metallic tubes in the form of edges joined in the shape of a “U”, wherein two of the three edges are parallel and vertically arranged, and joined to the region of two nodes, one at each of its ends, with a third horizontal edge in relation to the two parallel edges. Particularly, the horizontal edge has three through holes, of which one is centrally arranged, while the remaining two are arranged, each, at a distance ‘A’ and a distance ‘B’, see FIG. 3, opposite to each other and counted from each of the ends of the horizontal edge.

Furthermore, in a preferred embodiment, two projections are arranged, see FIG. 9, preferably in the form of stainless steel wire windings, on the steel cables in the region where these cables pass through the limiters, one before the passage and the other after the passage. Additionally, a tie is proposed, preferably as a metallic thread, to be passed through the edge end of the blanket and extended to surround the limiter arranged at this point of the blanket; see item 33 of FIG. 8.

Particularly, in the preferred embodiment, the blanket is composed of a series of overlapping materials capable of solving a gas leak in pipes subjected to high temperatures, preferably a fiberglass fabric coated with silicone, a ceramic fiber blanket, aramid fabric and ceramic fiber fabric. The width of the blanket determines the width of the limiters, and the height of the vertical edges is determined so that it is above the level of the blanket selected for maintenance; see FIG. 6.

In this first preferred embodiment, the limiters surround the blanket, and the cables exert pressure on the blanket over the expansion joint to be repaired, the open “U” part of the limiters shape guiding and compressing the expansion joint under repair.

In particular, the total length of the device is determined by what is required to enclose the expansion joint completely, wherein the origin of the device and the end edge of the device are coincident with and at the ends of the cut and secured cables.

Aligned Situation:

Additionally, the invention describes a second embodiment of a gas leak elimination device for sealing a gas leak in an expansion joint arranged between two pipes aligned with each other, the device comprising a sealing blanket, steel cables, straps and fastening elements to fully enclose the expansion joint; see FIG. 16.

In particular, the straps are arranged on the outer surface of the blanket and fixed to it by means of fastening elements, arranged on the inner surface of the blanket; see FIG. 10.

In this second embodiment, rivets are used to secure the structure made up of a blanket (see FIG. 10), straps (see FIG. 13) and fastening elements (see FIG. 16). Fasteners and straps adjust the blanket to withstand different operating conditions.

In particular, for each strap a plurality of fastening elements is provided; see FIG. 13, wherein each fastening element is positioned equidistant with respect to the adjacent fastening element in the same row of the fastening elements.

In addition, in this second embodiment of the invention, each strap comprises “U” shaped guides, see FIG. 14, to guide a metallic cable that will pass through them for securing and tightening the device, in which each strap guide is spaced in relation to another adjacent guide by an angle α, see FIG. 12, when the device encloses the joint.

Additionally, the present invention also describes a method for installing a device for eliminating gas leaks that enables the complete maintenance of an expansion joint between two gas circulation pipes at high temperatures, wherein the method comprises, at least the steps of: a) hoisting a device to eliminate gas leaks; b) guiding the device to the location of the expansion joint to be repaired; c) completely enclosing the expansion joint with the device comprising the thermal blanket; and d) tensioning the device cables using hoists in the defective region.

In particular, stage c) of tensioning ends when the leak tightness is identified.

This embodiment of the method of the invention further comprises the use of a ventilation system to reduce the temperature around the expansion joint leak region, and to reduce the levels of environmental contamination, in order to mitigate respiratory risks. Finally, the method described herein comprises grasping the ends of the cables, joining the cable ends of each cable by means of a steel cable clamp, and subsequently removing the hoist.

### BRIEF DESCRIPTION OF DRAWINGS

To obtain a total and complete visualization of the object of the present invention, the drawings to which references are made are presented, as follows.

FIG. 1 shows a device for eliminating gas leaks, for a misaligned situation, according to an exemplary configuration of the present invention.

FIG. 2 shows a front view of a limiter, for a misaligned situation, according to an exemplary configuration of the present invention.

FIG. 3 shows the bottom of a limiter, for a misaligned situation, according to an exemplary configuration of the present invention.

FIG. 4 shows a side view of a limiter, for a misaligned situation, according to an exemplary configuration of the present invention.

FIG. 5 shows a thermal blanket, for a misaligned situation, according to an exemplary configuration of the present invention.

FIG. 6 shows a layered structure of a thermal blanket, for a misaligned situation, according to an exemplary configuration of the present invention.

FIG. 7 shows a metallic structure, for a misaligned situation, according to an exemplary configuration of the present invention.

FIG. 8 shows in detail a tie made in limiters, for a misaligned situation, according to an exemplary configuration of the present invention.

FIG. 9 shows the detail of a projection, according to an exemplary configuration of the present invention.

FIG. 10 shows another device for eliminating gas leaks, for an aligned situation, according to an exemplary configuration of the present invention.

FIG. 11 shows a strap to be used with the other device, for an aligned situation, according to an exemplary configuration of the present invention.

FIG. 12 shows an assembly comprising a strap and guides, for an aligned situation, according to an exemplary configuration of the present invention.

FIG. 13 shows fastening elements in detail, for an aligned situation, according to an exemplary configuration of the present invention.

FIG. 14 shows in detail a guide, for an aligned situation, according to an exemplary configuration of the present invention.

FIG. 15 shows another device for eliminating gas leaks before being installed in an expansion joint, for an aligned situation, according to an exemplary configuration of the present invention.

FIG. 16 shows another device for eliminating gas leaks during installation in an expansion joint, for an aligned situation, according to an exemplary configuration of the present invention.

FIG. 17 shows another device for eliminating gas leaks, for an aligned situation, after installation in an expansion joint, according to an exemplary configuration of the present invention.

### DETAILED DESCRIPTION OF THE INVENTION

The present invention relates to a device for eliminating gas leaks, which has been identified in a fabric expansion joint arranged between gas pipes. In particular, the invention provides a device capable of servicing a joint between pipes that are in a misaligned situation and, additionally, provides a device capable of servicing a joint between pipes that are in an aligned situation.

It should be noted that this is the preferred method of applying the invention; however, the gas leak elimination device of the invention can be applied to other regions of the gas piping, other than the expansion joint, as well as expansion joints of materials other than fabric.

Misaligned Situation:

Furthermore, in the preferred embodiment of the invention, the device for eliminating gas leaks is designed to meet a demand in which a misalignment relationship between pipes is observed. Later, a second embodiment will be presented, in which the disclosed device also meets the demand with two aligned pipes.

It should be noted that the operation to eliminate the gas leak provided with the device disclosed in the present invention occurs entirely with the gas line in operation, without requiring downtime, nor complete replacement of the sealing gasket that presents the leak. In addition, the installation takes place with a person located at a distance from the pipe, enough to ensure that the user's safety conditions are preserved, as gas pipes can present very high temperatures. As an example, a CO₂ pipeline, which is perfectly suited to the proposed invention, can work with CO₂ at 465° C.

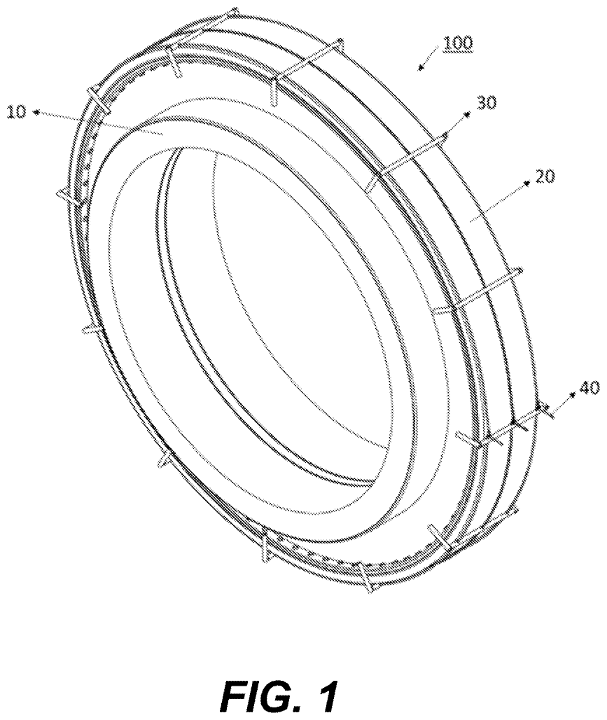

In this sense, in particular, the device for eliminating gas leaks 100 of the invention, in its preferred embodiment, that is, to service sealing joints arranged between pipes that are misaligned with each other, comprises a metallic structure 50 available for receiving, in the sense of containing, a sealing blanket 20. FIG. 1 provides a representation of the device 100 in a condition mounted on an expansion joint 10.

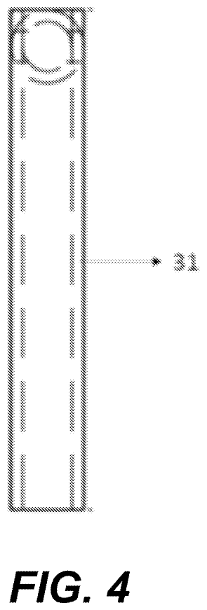

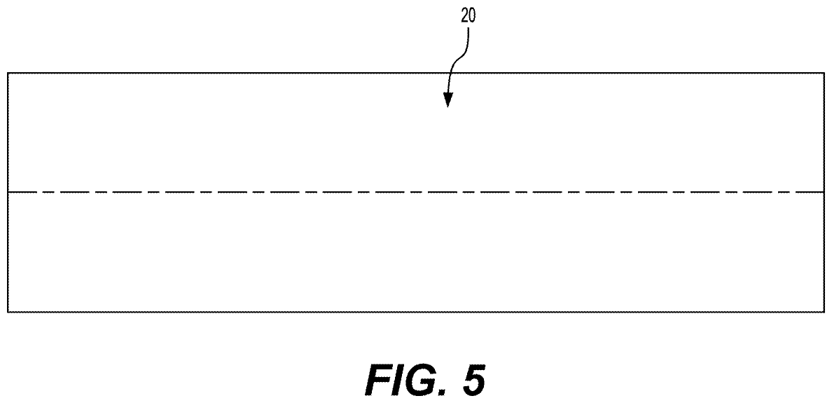

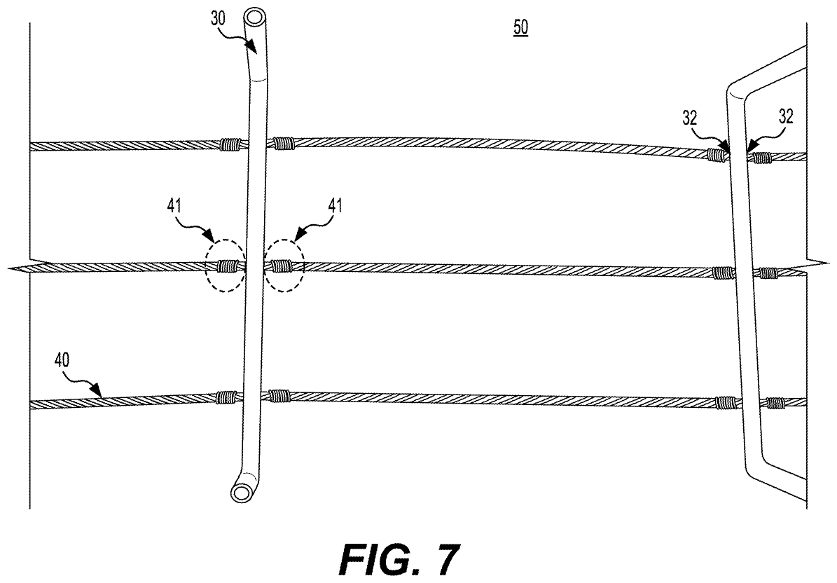

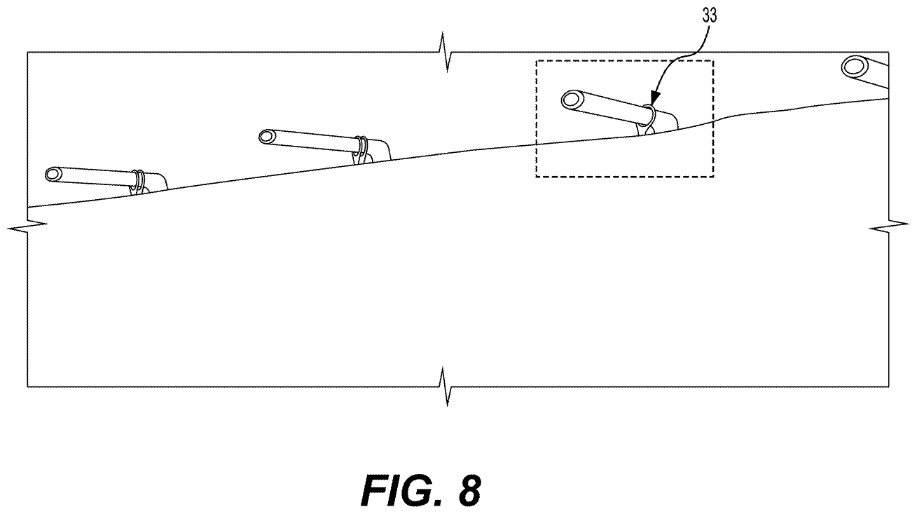

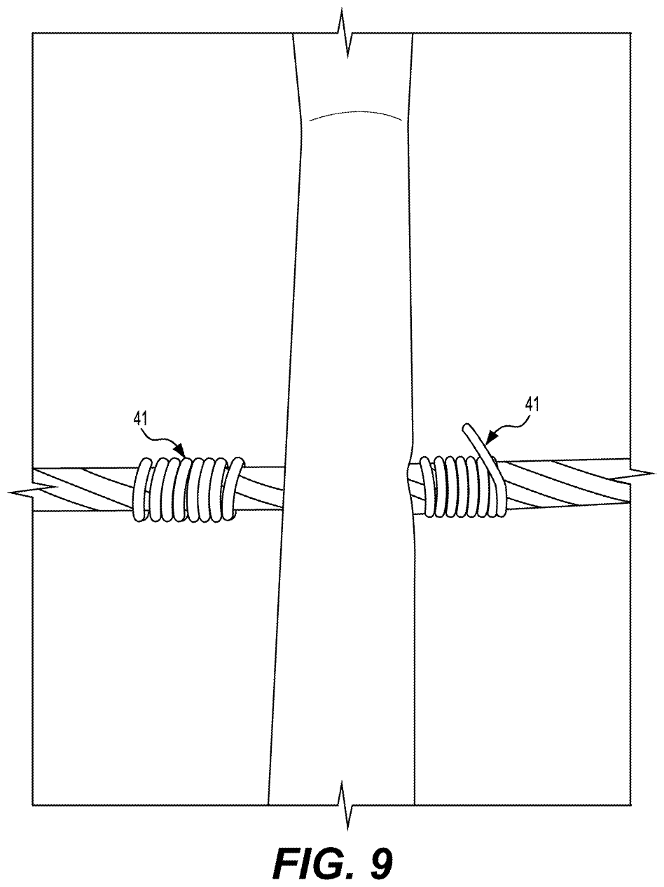

The metallic structure, in particular, comprises a series of multiple limiters 30. Reference is made to FIGS. 1 to 4 and, to contribute to the perfect visualization of the metallic structure, photographs in FIGS. 7 and 9 are proposed. Such elements are called limiters 30 because they contain the sealing blanket 20 at its lateral ends, that is, in its width, preventing undesirable movements of the blanket 20. In addition, with the aim of reinforcing this positioning, a tie 33 as exemplified in FIG. 8, must be made, comprising, for example, passing a metallic thread through the end of the blanket 20 and extending the end of this metallic thread so as to enclose the limiter 30 arranged at this point on the blanket. As the blanket is a structure, preferably made of fabric, passing a metallic thread is a viable alternative. Optionally, other mechanisms can be proposed with the same objective of enclosing the end of the blanket with the limiter 30 arranged at that particular point of the blanket 20.

Therefore, as introduced above, the limiters 30 assist in the perfect behavior of the blanket 20, maintaining the ideal positioning of said blanket 20 to service a given gas leak. Preferably, the limiters 30 are composed of metal tubes in the form of edges 31 arranged and joined in a “U” shape. In more detail, two edges 31 are parallel and vertically arranged and joined, at one of their ends, with a third edge 31 that assumes a horizontal position in relation to the two parallelly arranged edges 31. Precisely the union between the edges occurs at a node 33, with node 33 coinciding with the two ends of the horizontal edge 31. Depending on the proportions of the leak identified, the dimensions of the tubes selected for use, as well as their diameter, may be adapted accordingly, without deviating from the description of the invention.

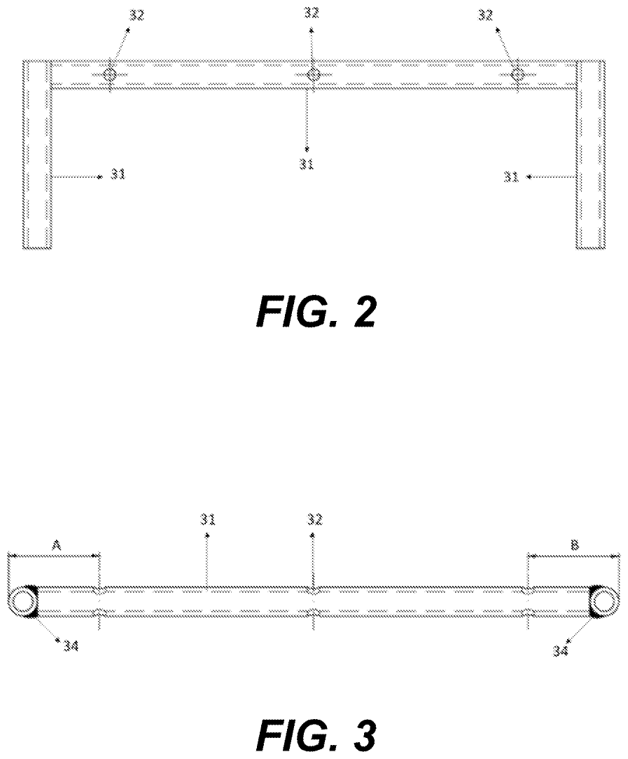

With reference to FIGS. 2 and 3, preferably, on the middle edge 31 of the “U”—horizontally arranged—three through holes 32 are distributed. Said through holes 32 are intended to receive the passage, in the direction of crossing, of three steel cables 40 which assume the condition of being arranged in parallel. The steel cables 40 further reinforce the safety of the blanket 20 and its correct positioning in the metallic structure of the device of the invention and, consequently, in the location of the leak to be repaired.

One of the three through holes 32 of the horizontal edge 31 is centrally disposed in said edge 31, while a second hole is proposed at the first end of the edge, respecting a distance ‘A’ from the end to the hole and, therefore, a third hole is proposed at the opposite end of the edge, respecting a distance ‘B’ from the end to the hole. Again, depending on the proportions of the leak identified and the pipes subject to repair, the dimensions of the steel cables can be perfectly adequate, maintaining the concepts of the invention.

Furthermore, as detailed in FIGS. 7 and 9, still with regard to the metallic structure, two projections 41, for example—not limiting—as stainless steel wire windings, are positioned on the steel cables 40 in the region of the passages of these cables 40 by limiters 30, one before the passage and one after the passage. This is applied to prevent the limiters from running down the cable length 40.

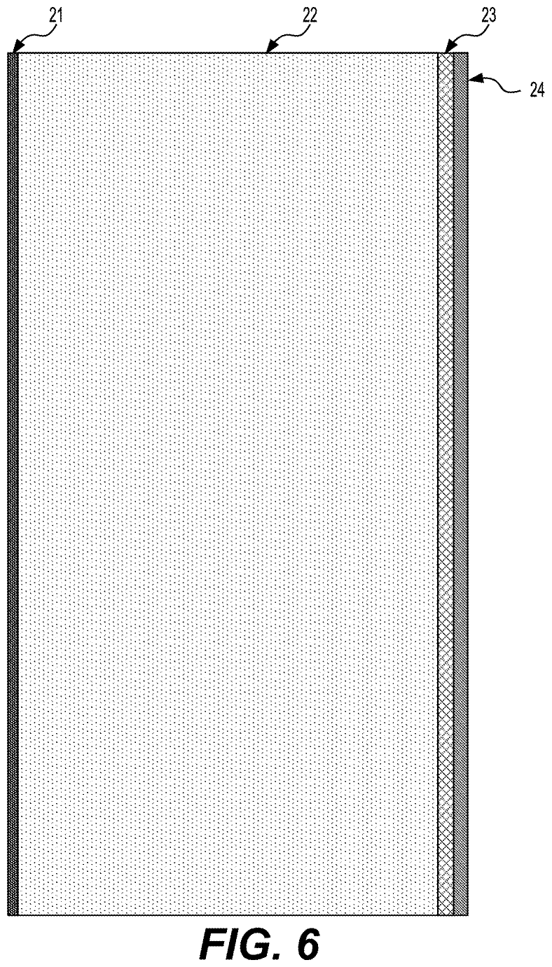

In addition to the metallic structure, the device 100 of the invention also comprises the sealing blanket 20 which, as previously mentioned, will be disposed on said metallic structure. The sealing blanket 20, see FIG. 6, is preferably composed of a series of overlapping materials capable of solving a gas leak in pipes subjected to high temperatures. There are blankets suitable for this purpose commercially available, but nothing prevents one from preparing a blanket, for example, by adapting the materials for a particular purpose, to meet a particular demand. By way of example, FIG. 6 illustrates a blanket composed of a silicone-coated glass fiber fabric 21, a ceramic fiber blanket 22, an aramid fabric 23 and ceramic fiber fabric 24. The technical observation that determines the selection of the blanket to be used is the consideration of the characteristics of temperature, gas, etc., which are suitable for the repair operation in question. In the example of blanket 20 illustrated in FIG. 6, it is possible to service an environment with combustion gases, working pressure >2 Kgf/cm2 and working temperature in the order of >700° C.

Furthermore, by way of example, an exemplary measurement of the blanket of the invention comprises 8500 mm in length, with 450 mm in width. Again, this measure must be adequate to cover the identified hole, which will be subjected to maintenance, and a safety margin. It must be recognized that the adaptation of measurements does not alter the description of the invention. In this sense, a person skilled in the art understands perfectly that the width of the blanket determines the width of the limiters 30, since the blanket must be adjusted to these limits 30. Similarly, the height of the edges 31 can be determined such that they are above the level of the blanket, that is, greater than the blanket, and are guided by the fixing structure of the joint to be repaired. In practice, the limiters 30 embrace the blanket 20 and the steel cables 40 are, in this way, promoting pressure to support the blanket 20 over the expansion joint to be repaired. Therefore, note that the open part of the “U” shape of the limiters 30 is what contacts the expansion joint and embraces the joint under repair. It is highlighted that in the proposed invention the device encloses the expansion joint to be repaired in its entirety and, the start and the end of the device are, therefore, terminations of the steel cables 40, cut and secured at sufficient length in which no gas leak was observed. FIG. 1 represents this termination well, arranged in the region of the numerical indication of cables 40.

Aligned Situation:

Next, a description is made in relation to a device for eliminating gas leaks to meet a demand in which an alignment relationship between pipes is observed, according to a second embodiment of the present invention.

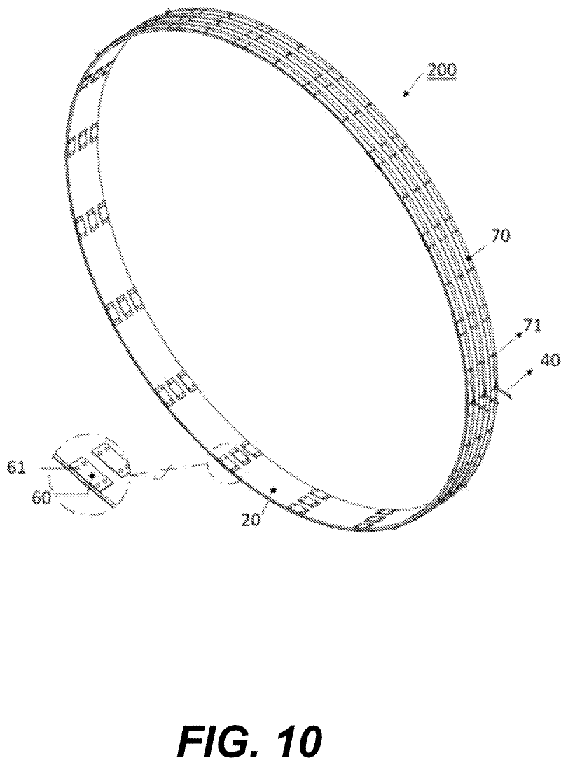

FIG. 10, therefore, shows the device for eliminating gas leaks 200 for pipe alignment conditions. In this embodiment, the device 200 comprises a sealing blanket 20, steel cables 40, straps 70 and fastening elements 60.

The straps 70 are arranged on the outer surface of the blanket 20 and fixed thereto by means of the fastening elements 60, arranged on the inner surface of the blanket 20. To secure the structure consisting of blanket 20, straps 70 and fastening elements 60, preferably rivets 61 are used. However, it is clear that other forms of fastening could be used. It is worth noting that this tie structure composed of fastening elements 60 and straps 70 has the function of adjusting the blanket to resist different operating conditions, depending on the speed and/or temperature of the fluid passing through the pipe.

According to an exemplary configuration of the present invention, shown in FIG. 10, the device 200 comprises three straps 70, arranged in parallel. Accordingly, for each strap 70, a plurality of fastening elements 60 are provided, wherein each fastening element 60 is disposed on the inner surface of the blanket 20 and positioned substantially equidistant with respect to the adjacent fastening element in the same row of fastening elements.

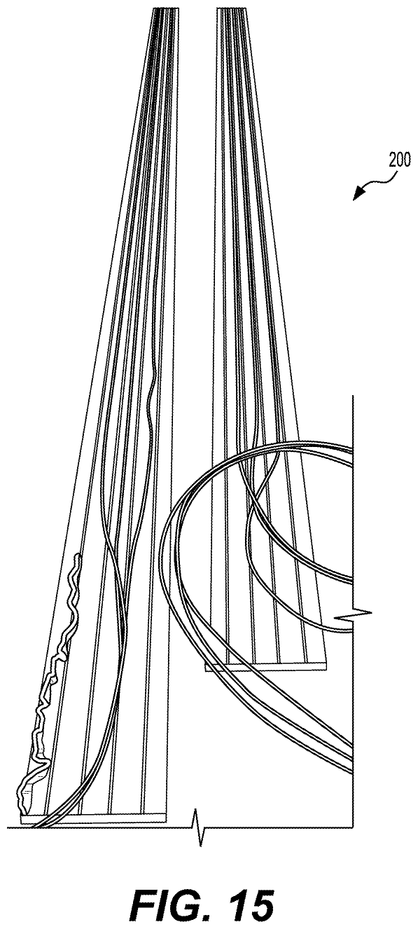

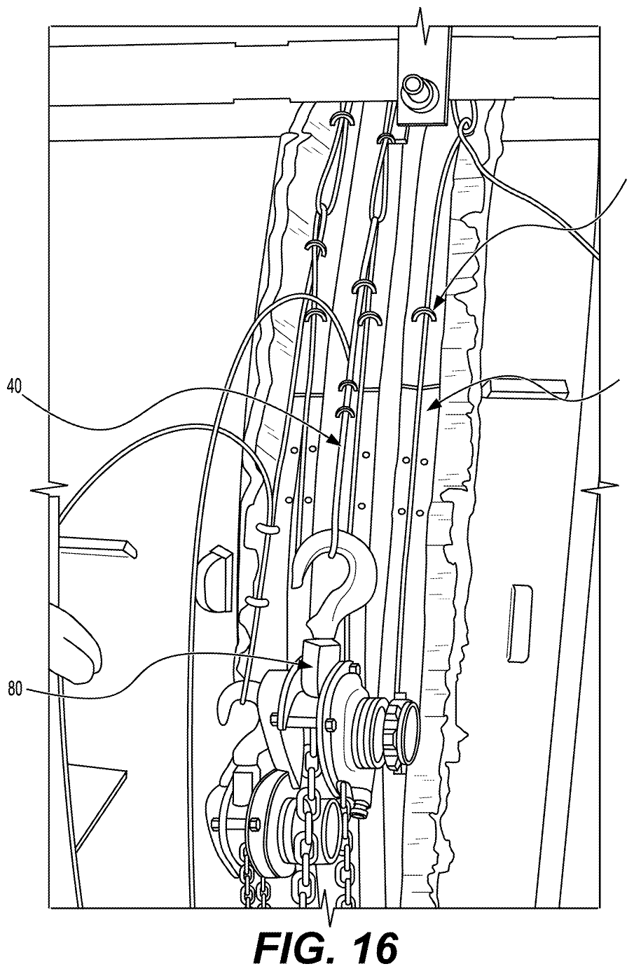

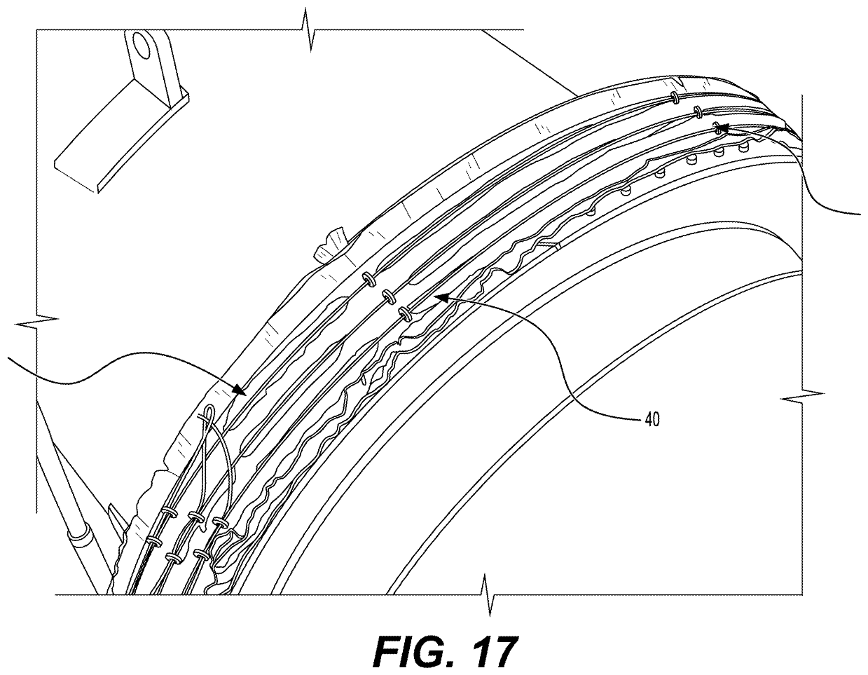

FIGS. 10 to 14 exemplify the gas leak elimination device 200 and show details of its main constituent elements. The photographs in FIGS. 15 to 17 contribute to the perfect visualization of the device 200 during its assembly stages, installation in the joint and configuration after installation.

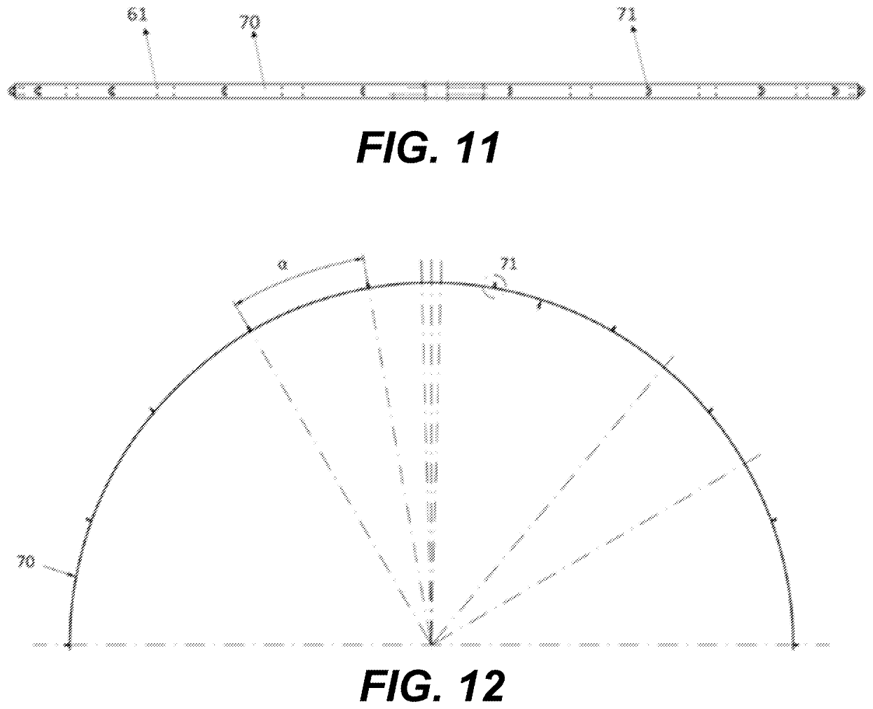

Specifically, FIGS. 11 and 12 show in detail a strap 70 used in the device. Said strap 70, preferably made of metallic materials or any other material that guarantees its flexibility and mechanical resistance and resistance to high temperatures, comprises “U” shaped guides 71 to guide a metallic cable or thread 40 that will pass through them to secure and tighten the device. Each guide 71 of the strap 70 being spaced relative to another adjacent guide by an angle “α”, when the device 200 encloses the joint, as shown in FIG. 12.

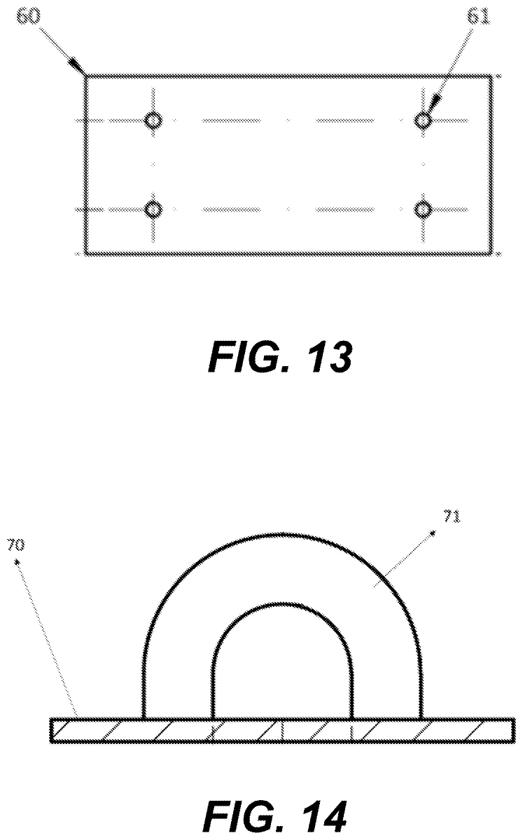

FIG. 13 shows in detail a fastening element 60 used to secure the strap 70 to the blanket 20, according to the second embodiment of the present invention. The fastening element 60 has a substantially rectangular shape with holes for placing the rivets 61. It is worth noting that the rectangular shape, as well as the number of rivets to be used, is not limited to these configurations, so that other formats for the fastening element 60 can be used with the same objective of fastening the strap 70 to the blanket.

FIG. 14 shows an exemplary configuration of one of the multiple guides 71 used to receive the metallic thread, to be passed through them, and its correct alignment on the strap 70.

The present invention further provides a method for installing a gas leak elimination device. Using the method of the present invention, it is possible to provide the complete maintenance of an expansion joint that is between two gas circulation pipes at high temperatures, without requiring the presence of a contractor on site.

As mentioned previously, the environment in which these expansion joints 10 are located is completely unsafe for the presence of a maintenance worker. These are conditions of very high temperatures and extreme risks. In this sense, the structure of the device described herein, in its initially disclosed embodiments, is decisive in enabling maintenance without the need for an on-site contractor.

According to a preferred embodiment, the method comprises: hoisting a gas leak elimination device 100, 200; enclosing the expansion joint 10 in the device 100, 200 comprising the thermal blanket 20; and tensioning the steel cables 40 using hoists 80 to adjust the device 100, 200 to the defective region until the leak is sealed, wherein the operator is positioned at a distance during the procedure.

During the method of installing the device 100, 200, the present invention further provides for the use of a ventilation system to reduce the temperature around the leakage region of the joint.

Additionally, the method further comprises securing the ends of the steel cables by joining the cable ends of each steel cable to each other using a steel cable clamp to maintain tension. After securing the ends of the cables, the hoist 80 is removed.

Those skilled in the art will value the knowledge presented herein and will be able to reproduce the invention in the disclosed embodiments and in other variations within the scope of the attached claims.

1. A device for eliminating gas leaks, comprising a metallic structure containing a sealing blanket, in which the metallic structure and the blanket fully enclose an expansion joint by cables, wherein the metallic structure is configured to seal a gas leak in the expansion joint arranged between two pipes misaligned with each other.

2. The device according to claim 1, wherein the metallic structure comprises a plurality of limiters arranged at an acute angle with respect to each other, comprising three metallic pipes forming joined edges in a U-shape,
wherein two edges are parallel and vertically arranged, and joined to a region of two nodes, one at each of its ends, with a third edge horizontal in relation to the two edges that are parallelly and vertically arranged;
wherein the third edge has three through holes, of which one is centrally arranged, while two remaining through holes are arranged, each, at a first distance and a second distance, opposite to each other and counted from each of the ends of the third edge.

3. The device according to claim 2, wherein two projections comprising stainless steel wire windings are arranged on the cables in a region of passages of these cables by limiters, one before a passage and one after the passage, wherein the cables comprise steel.

4. The device according to claim 3, wherein a tie, comprising a metallic thread, is configured to pass through an edge end of the blanket and extend to enclose the limiter arranged at this point on the blanket.

5. The device according to claim 1, wherein the blanket comprises a series of overlapping materials configured to seal a gas leak in pipes subjected to high temperatures, wherein the overlapping materials comprise a material selected from the group consisting of a fiberglass fabric coated with silicone, a ceramic fiber blanket, an aramid fabric ceramic, fiber fabric, or combinations thereof.

6. The device according to claim 3, wherein a width of the blanket determines a width of the limiters and a height of the two edges that are vertically arranged are determined such that each is above a level of the blanket selected for maintenance.

7. The device according to claim 3, wherein the limiters are configured to embrace the blanket, and the cables are configured to exert pressure on the blanket over the expansion joint to be repaired, an open part of the U-shape of the limiters contacting the expansion joint under repair.

8. The device according to claim 1, wherein a size of a total length of the device is determined by what is necessary to enclose the expansion joint completely, wherein a start and an end of the device are coincident with and at ends of the cables that are cut and secured.

9. A device for eliminating a gas leak, comprising a sealing blanket, steel cables, straps, and fastening elements to fully enclose an expansion joint, wherein the device is configured to seal a gas leak in the expansion joint arranged between two pipes aligned with each other.

10. The device according to claim 9, wherein the straps are arranged on an outer surface of the blanket and fixed thereto by fastening elements arranged on an inner surface of the blanket.

11. The device according to claim 9, further comprising rivets configured to secure a structure comprising the blanket, straps, and fastening elements.

12. The device according to claim 9, wherein the fastening elements and the straps are configured to adjust the blanket to resist different operating conditions.

13. The device according to claim 9, wherein a plurality of fastening elements is provided for each strap, wherein each fastening element is positioned equidistant with respect to an adjacent fastening element in a same row of fastening elements.

14. The device according to claim 9, wherein each strap comprises “U” shaped guides configured to guide a metallic cable that will pass through for securing and tightening the device, and wherein each guide is spaced relative to another adjacent guide by an angle (a), when the device encloses the joint.

15. A method for installing a device to eliminate gas leaks, comprising the steps of:
a) hoisting a device for eliminating gas leaks;
b) guiding the device to a location of an expansion joint between two gas circulation pipes to be subjected to repair;
c) completely enclosing an expansion joint with the device comprising a thermal blanket; and
d) tensioning cables of the device using one or more hoists to a defective region between the two gas circulation pipes.

16. The method according to claim 15, wherein step c) further comprises tensioning ends when a tightness of the leak is identified.

17. The method according to claim 15, further comprising reducing a temperature around a leak region of the expansion joint using a ventilation system.

18. The method according to claim 15, further comprising grasping ends of the cables, joining the ends of each cable by a steel cable clamp, and subsequently removing the one or more hoists.
